(19) United States
(12) Patent Application Publication
(10) Pub. No.: US 2015/0028942 A1
(43) Pub. Date: Jan. 29, 2015

(54) SEMICONDUCTOR INTEGRATED CIRCUIT AND POWER MANAGEMENT SYSTEM

(71) Applicant: KABUSHIKI KAISHA TOSHIBA, Tokyo (JP)

(72) Inventor: Shohei FUKUDA, Kanagawa (JP)

(73) Assignee: KABUSHIKI KAISHA TOSHIBA, Tokyo (JP)

(21) Appl. No.: 14/191,341

(22) Filed: Feb. 26, 2014

(30) Foreign Application Priority Data
Jul. 26, 2013 (JP) 2013-155939

(51) Int. Cl. G05F 1/46

(52) U.S. Cl. CPC G05F 1/462
USPC 327/540

(57) ABSTRACT

An embodiment of a semiconductor integrated circuit, which receives a power supply voltage at an input terminal and outputs a feedback voltage for controlling a level of the power supply voltage, includes a feedback voltage generating unit that generates the feedback voltage corresponding to the level of the power supply voltage at the input terminal. The feedback voltage generating unit includes a variable resistance element. A resistance control unit controls the resistance value of the variable resistance element to account for changes in a desired target level for the power supply voltage.

### CROSS-REFERENCE TO RELATED APPLICATION

This application is based upon and claims the benefit of priority from Japanese Patent Application No. 2013-155939, filed Jul. 26, 2013, the entire contents of which are incorporated herein by reference.

### FIELD

Embodiments described herein relate generally to a semiconductor integrated circuit and a power management system.

### BACKGROUND

Due to factors such as variation in manufacturing, semiconductor integrated circuits do not necessarily exhibit constant performance. For example, if a power supply voltage is supplied to semiconductor integrated circuits selected from a batch of nominally identical semiconductor circuits, the operation speeds of some semiconductor integrated circuits in the batch will be high and others will be low. Further, the operation speed (maximum clock rate) and leakage power of each semiconductor integrated circuit correlate with each other such that leakage power (power consumption level) of a semiconductor integrated circuit having a relatively low operation speed is relatively small, and leakage power of a semiconductor integrated circuit having a relatively high operation speed is relatively large. As used in this context, leakage power refers to power consumed by an integrated circuit device even in, for example, a standby or inactive state.

For semiconductor integrated circuits whose operation speeds are low, the power supply voltage may be set to be sufficiently high to improve operating speeds. For semiconductor integrated circuits whose operation speeds are high, the power supply voltage may be set to be low to reduce leakage power. By adjusting the power supply voltage, it is possible to improve the effective manufacturing yield of semiconductor integrated circuits. The control on the power supply voltage to adjust individual circuit performance is called voltage identification (VID) control.

Also, in some semiconductor device applications a priority may be placed on the requirement for high-speed operations. In other applications, only relatively low-speed operations may be required and reduced power consumption may instead be a priority. In applications requiring a high-speed operation, it is preferable to set the power supply voltage sufficiently high to provide high speed operations. In low speed (or low power consumption applications), it is preferable to set the power supply voltage to be relatively low. When the power supply voltage is adjusted according to required operating speeds for specific applications, dynamic control of the power supply voltage is called dynamic voltage and frequency scaling (DVFS) control.

Accordingly, the power supply voltage supplied to semiconductor integrated circuits may be controlled according to inherent differences in the manufactured integrated circuits or in response to different application requirements.

### DESCRIPTION OF THE DRAWINGS

FIG. 1 depicts a configuration of a power management system according to a first embodiment.

FIG. 2 illustrates the relationship among the performance, target voltage Vdd0, the value {R1/(R1+R2)}, and resistance value R2 of a semiconductor integrated circuit in VID control.

FIG. 3 illustrates the relationship among the operation frequency (performance), target voltage Vdd0, value of {R1/(R1+R2)}, and resistance value R2 of the semiconductor integrated circuit in DVFS control.

FIG. 4 depicts a configuration of a power management system according to a second embodiment.

### DETAILED DESCRIPTION

Embodiments provide a semiconductor integrated circuit and a power management system for controlling a power supply voltage.

An embodiment of a semiconductor integrated circuit includes a power supply voltage input terminal at which a power supply voltage is to be applied and a feedback voltage output terminal at which a feedback voltage for controlling a level of the power supply voltage is to be output.

The integrated circuit also includes a feedback voltage generating unit configured to generate the feedback voltage corresponding to the level of the power supply voltage and including a variable resistive element. The feedback voltage is used to control the power supply voltage level such that the power supply voltage level approaches a target level.

The integrated circuit further includes a resistance control unit configured to control a resistance value of the variable resistive element according to changes in the target level of the power supply voltage. Thus, if the target level of the power supply voltage is changed to a level required for the integrated circuit to achieve a desired operating speed and/or power consumption level, the resistance level of the variable resistive element can be varied such that the feedback voltage is generally within a preferred operating range, for example.

Hereinafter, example embodiments will be described with reference to the accompanying drawings.

### First Embodiment

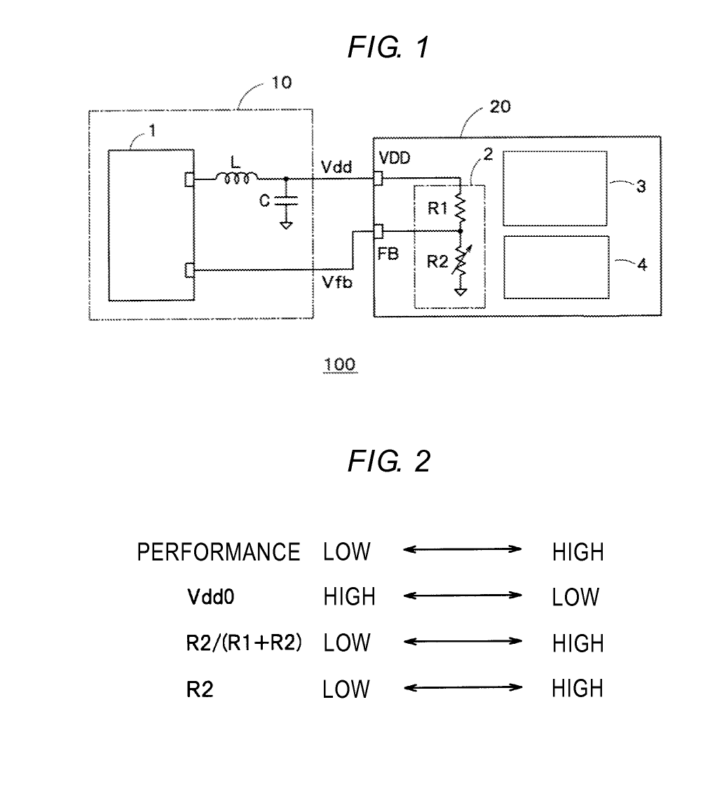

FIG. 1 is a block diagram depicting a configuration of a power management system 100 according to a first embodiment. The power management system 100 includes a power management device 10 and a semiconductor integrated circuit 20. The power management system 100 manages a power supply voltage Vdd to be supplied to the semiconductor integrated circuit 20.

The power management device 10 may be a DC to DC converter or a low drop out (LDO) regulator composed of a power management integrated circuit (PMIC) 1, an inductor (coil) L, and a capacitor C. The PMIC 1 may, but need not necessarily, have a VID and/or DVFS control function.

The power management device 10 outputs the power supply voltage Vdd to be supplied to the semiconductor integrated circuit 20. The semiconductor integrated circuit 20 outputs a feedback voltage Vfb, corresponding to the supplied power supply voltage Vdd, to the power management device 10. Then, the power management device 10 controls the power supply voltage Vdd to be output such that the feedback voltage Vfb becomes a certain value Vfb0 (for example, 1.0 V) preset or otherwise stored in the PMIC 1.

In the power management system 100, it is assumed that as the power supply voltage Vdd increases, the feedback voltage Vfb increases. Therefore, in a case where the feedback voltage Vfb is higher than the certain value Vfb0, the power management device 10 reduces the value of the power supply voltage Vdd to be output. When the feedback voltage Vfb is lower than the certain value Vfb0, the power management device increases the value of the power supply voltage Vdd to be output.

This feedback control causes the power management device 10 to output the power supply voltage Vdd to the semiconductor integrated circuit 20 such that the feedback voltage Vfb finally becomes the certain value Vfb0.

The semiconductor integrated circuit 20 is any circuit which operates at the power supply voltage Vdd. For example, semiconductor integrated circuit 20 may be a so-called “system on a chip” (SoC) or a memory system. The semiconductor integrated circuit 20 includes a power supply terminal VDD which is an input terminal, a feedback terminal FB which is an output terminal, a feedback voltage generating unit 2, a target voltage setting unit 3, and a resistance control unit 4.

The power supply terminal VDD receives the power supply voltage Vdd output from the power management device 10. The feedback terminal FB outputs the feedback voltage Vfb according to the power supply voltage Vdd to the power management device 10.

The feedback voltage generating unit 2 is a circuit for generating the feedback voltage Vfb from the power supply voltage Vdd. Specifically, the feedback voltage generating unit 2 includes resistive elements R1 and R2 which are connected in series between the power supply terminal VDD and a ground terminal. Further, the connection node of the resistive elements R1 and R2 is connected to the feedback terminal FB through which the feedback voltage Vfb is output.

Each of the resistive elements R1 and R2 in this example embodiment has a resistance value of about several kΩ (10³ ohms), and the resistive element R2 is a variable resistive element. Hereinafter, “R1” and “R2” are used not only as the reference symbols of the resistive elements but also as the resistance values of the respective resistive elements.

As is obvious from the depicted circuit configuration, the relationship between the supplied power supply voltage Vdd and the feedback voltage Vfb can be expressed by the following Expression (1):

Vfb=Vdd*R2/(R1+R2) Expression (1)

The target voltage setting unit 3 sets a target voltage Vdd0 to be supplied from the power management device 10 to the semiconductor integrated circuit 20. As specific examples of a method of setting the target voltage Vdd0, the following VID control and DVFS control methods are described for explanatory purposes.

First, the VID control example will be described. Even if a certain power supply voltage is supplied to the semiconductor integrated circuit 20, due to factors such as variation in manufacturing, the semiconductor integrated circuit 20 may operate at a relatively high speed or at a low speed. For this reason, the target voltage setting unit 3 sets the target voltage Vdd0 according to the performance parameters of the semiconductor integrated circuit 20. This is referred to as VID control.

Here, the performance parameters means, for example, an operation speed and leakage power in a case of supplying a certain power supply voltage to the semiconductor integrated circuit 20.

In the VID control, in order to suppress variations in the operation speed and leakage power, with respect to a semiconductor integrated circuit 20 whose operation speed is relatively low and whose amount of leakage power is small, the target voltage Vdd0 is set to be high. With respect to a semiconductor integrated circuit 20 whose operation speed is relatively high and whose amount of leakage power is large, the target voltage Vdd0 is set to be low.

Therefore, with respect to a semiconductor integrated circuit 20 whose operation speed is relatively low and whose amount of leakage power is small, the operation speed increases, and the leakage power also increases as the target voltage Vdd0 is set relatively higher than a nominal target voltage Vdd0. With respect to a semiconductor integrated circuit 20 whose operation speed is relatively high and whose amount of leakage power is large, the operation speed decreases, and the leakage power decreases as the target voltage Vdd0 is set relatively lower than a nominal target voltage Vdd0. Thus, it is possible to suppress variations among different semiconductor integrated circuits 20, and to increase the effective manufacturing yield of semiconductor integrated circuits which satisfy both the nominal operation speed performance characteristic and nominal leakage power performance characteristic.

In the case of the VID control, the target voltage Vdd0 can be statically set according to the measured performance of each semiconductor integrated circuit 20, and need not dynamically vary during an operation. Therefore, it is necessary only to evaluate the operation speed of the semiconductor integrated circuit 20 in advance, and then write the target voltage Vdd0 required for obtaining a desired operation speed in a memory unit (not specifically depicted) in the target voltage setting unit 3.

Now, DVFS control will be described. Even in a single semiconductor integrated circuit 20, for some processes, high-speed operations are required, and for other processes, low-speed operations are sufficient. Therefore, when the semiconductor integrated circuit 20 performs a process requiring a high-speed operation, the target voltage setting unit 3 sets the target voltage Vdd0 to be high to provide high-speed operation. When the semiconductor integrated circuit 20 performs a process for which a low-speed operation is sufficient, the target voltage setting unit 3 sets the target voltage Vdd0 to be low to reduce power consumption. This control method is referred to as DVFS control.

In the case of the DVFS control, the target voltage Vdd0 is dynamically set according to the required operation speed of the semiconductor integrated circuit 20. The required operation speed may be provided from a processing unit (not specifically depicted) inside semiconductor integrated circuit 20 to the target voltage setting unit 3. Alternatively, the required operation speed may be provided to the target voltage setting unit 3 from an external micro computer (not specifically depicted) or the like, which is outside the semiconductor integrated circuit 20 and controls the inside of the semiconductor integrated circuit 20.

Alternatively, the target voltage setting unit 3 may set the target voltage Vdd0 in view of at least one of the performance parameters of the semiconductor integrated circuit 20 and the operation speed of the semiconductor integrated circuit 20, or may set the target voltage Vdd0 in view of any other factors.

Referring to FIG. 1 again, the resistance control unit 4 performs variable control on the resistance value R2 of the resistive element R2 such that the power supply voltage Vdd to be supplied becomes the target voltage Vdd0. More specifically, the resistance control unit 4 sets the resistance value R2 to satisfy the following Expression (2) or the following Expression (3), which is a rearrangement of the Expression (2).

Vfb0=Vdd0*R2/(R1+R2) Expression (2)

R2=R1*Vfb0/(Vdd0-Vfb0) Expression (3)

If the above described feedback control of the power management device 10 is performed as described above, the feedback voltage Vfb becomes the certain value Vfb0, and as a result, the power supply voltage Vdd becomes the target voltage Vdd0.

As an example, the certain value Vfb0 is set to 1.0 V, and the resistance value R1 is 2 kΩ. In a case where the target voltage Vdd0 is 2 V, the resistance control unit 4 sets the resistance value R2 to 2 kΩ. In a case where the target voltage Vdd0 is 3 V, the resistance control unit 4 sets the resistance value R2 to 1 kΩ, per Expression (3).

If the power supply voltage Vdd is higher than the target voltage Vdd0 of 2 V, the feedback voltage Vfb becomes higher than Vfb0 of 1 V. Therefore, to drop the feedback voltage Vfb to the certain value Vfb0 of 1 V, the power management device 10 reduces the power supply voltage Vdd. When the power supply voltage Vdd is lower than the target voltage Vdd0 of 2 V, the feedback voltage Vfb becomes lower than 1 V. Therefore, to increase the feedback voltage Vfb up to the certain value Vfb0 of 1 V, the power management device 10 increases the power supply voltage Vdd.

This feedback control causes the power supply voltage Vdd to be 2 V.

FIG. 2 is a view schematically illustrating the relation among the performance, target voltage Vdd0, value of {R1/(R1+R2)}, and resistance value R2 of the semiconductor integrated circuit 20 in the VID control.

As depicted in FIG. 2, if the performance (e.g., operation speed) of the semiconductor integrated circuit 20 is low, the target voltage setting unit 3 sets the target voltage Vdd0 to be high to increase the operation speed. In this case, it is necessary to reduce a value of {R2/(R1+R2)} on the basis of the above described Expression (2), and thus the resistance control unit 4 reduces the resistance value R2.

In this way, with respect to a semiconductor integrated circuit 20 whose operation speed is low, a high power supply voltage Vdd is supplied such that the operation speed becomes higher, and with respect to a semiconductor integrated circuit 20 whose operation speed is high, a low power supply voltage Vdd is supplied such that the operation speed becomes lower. As a result, it is possible to account for variations among semiconductor integrated circuits 20.

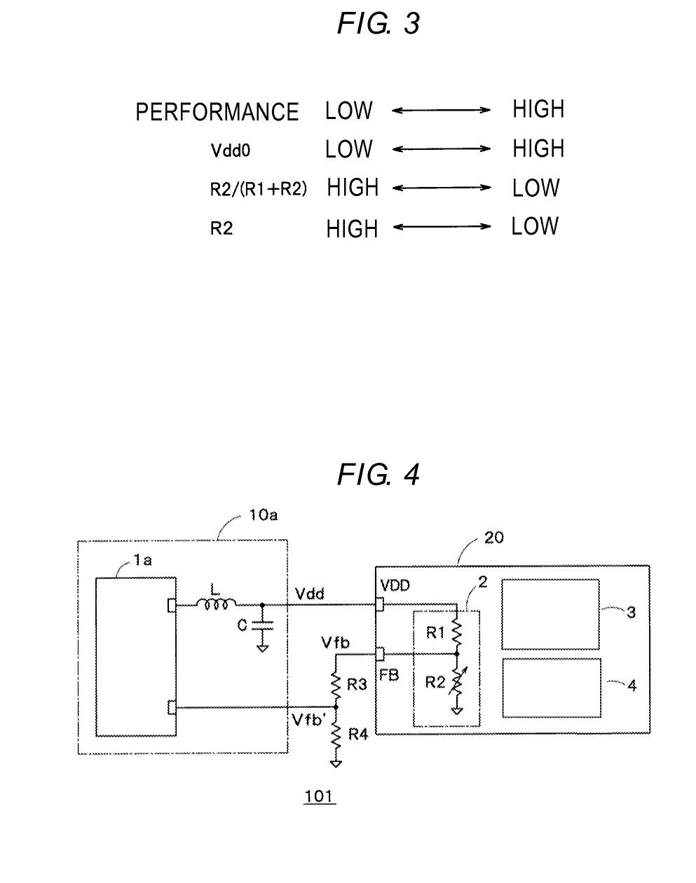

FIG. 3 depicts the relationship among the operation frequency (performance), target voltage Vdd0, value of {R1/(R1+R2)}, and resistance value R2 of the semiconductor integrated circuit 20 in the DVFS control.

As shown in FIG. 3, when operating the semiconductor integrated circuit 20 at a high speed is required, the target voltage setting unit 3 sets the target voltage Vdd0 to be high. In this case, it is necessary to reduce the value of {R2/(R1+R2)} on the basis of Expression (2), and thus the resistance control unit 4 reduces the resistance value R2.

When operating the semiconductor integrated circuit 20 at a low speed is required (or high speed operation is not required), the target voltage setting unit 3 sets the target voltage Vdd0 to be low. In this case, it is necessary to increase the value of {R2/(R1+R2)} on the basis of Expression (2), and thus the resistance control unit 4 increases the resistance value R2.

In this way, when a process requiring a high-speed operation is being performed, a high power supply voltage Vdd is supplied, whereby the semiconductor integrated circuit 20 can operate at a high speed. When a process for which a low-speed operation is sufficient is required, a low power supply voltage Vdd is supplied, whereby it is possible to reduce the power consumption of the semiconductor integrated circuit 20.

In the first example embodiment, the variable resistive element R2 is provided inside the semiconductor integrated circuit 20, and according to the target voltage Vdd0, variable control is performed by adjusting the resistance value of the variable resistive element R2. Therefore, according to the performance and operation speed of each semiconductor integrated circuit 20, it is possible to control the power supply voltage Vdd to be supplied to the corresponding semiconductor integrated circuit 20.

### Second Embodiment

In the first embodiment, the feedback voltage Vfb is output from the feedback terminal FB of the semiconductor integrated circuit 20 directly to the power management device 10. In a second embodiment, two resistive elements are connected in series between the feedback terminal FB and a ground terminal. The power management device 10 receives a feedback control voltage from a connection node between the two resistive elements (e.g., R3 and R4 in FIG. 4) rather than directly from the feedback terminal FB.

FIG. 4 is a block diagram depicting a configuration of a power management system 101 according to a second embodiment. In FIG. 4, components common to FIG. 1 are denoted by the same reference symbols, and hereinafter, description will be made mainly with respect to differences.

In FIG. 4, a PMIC 1a is used rather than a PMIC 1 depicted in FIG. 1. PMIC 1a performs control such that the feedback voltage becomes a predetermined certain value, and the certain value may be different depending on PMICs.

Meanwhile, the semiconductor integrated circuit 20 controls the resistance value R2 according to the above described Expressions (2) and (3) such that the feedback voltage Vfb approaches a certain value Vfb0. However, it is also possible that after manufacturing, the PMIC to be used is changed and the constant value Vfb becomes Vfb0′ different from Vfb0.

In the second embodiment, in order to make it unnecessary to change the semiconductor integrated circuit 20 even if the certain value from the PMIC to be used is changed resistive elements R3 and R4 are provided on the outside of the semiconductor integrated circuit 20.

The resistive elements R3 and R4 are provided on the outside of the semiconductor integrated circuit 20, and are connected in series between the feedback terminal FB and the ground terminal. In other words, one terminal of the resistive element R3 receives the feedback voltage Vfb, and one terminal of the resistive element R4 is grounded. Further, the feedback voltage Vfb′ from the connection node of the resistive elements R3 and R4 is input to a power management device 10a as feedback control value. Then, the power management device 10a controls the value of the power supply voltage Vdd to be output such that the feedback voltage Vfb′ becomes a predetermined certain value Vfb0′ (for example, 0.7 V).

The resistance values of the resistive elements R3 and R4 can be about several hundreds kΩ, and can be sufficiently larger than the resistance values of the resistive elements R1 and R2 that the value of the feedback voltage Vfb is approximately determined according to the resistance values R1 and R2, and can be approximated by the above described Expression (1). That is, between the case of FIG. 1 and the case of FIG. 4, the value of the feedback voltage Vfb need not vary significantly.

Furthermore, the resistance values R3 and R4 are determined to satisfy the following Expression (4).

Vfb0′=Vfb0*R4/(R3+R4) Expression (4)

For example, when the certain value Vfb0 is 1.0 V and the certain value Vfb0′ is 0.7 V, the resistance values R3 and R4 may be set to 300 kΩ and 700 kΩ, respectively.

In this way, the power management device 10a controls the power supply voltage Vdd such that the feedback voltage Vfb′ becomes the certain value Vfb0′, in other words, such that the feedback voltage Vfb becomes the certain value Vfb0.

As described, it is possible to use the power management device 10a for controlling the semiconductor integrated circuit 20 even though semiconductor integrated circuit 20 may have been manufactured on the assumption that a power management device 10 would be used for performing control of the power supply voltage on the basis of an assumed certain value Vfb0 rather than a feedback voltage at a certain value Vfb0′.

In the second embodiment, the resistive elements R3 and R4 are provided on the outside of the semiconductor integrated circuit 20, and the feedback voltage Vfb′ proportional to the voltage Vfb output from the semiconductor integrated circuit 20 is input to the power management device 10a. Therefore, it is possible to use a variety of power management devices (e.g., 10 or 10a) for performing control when a feedback voltage is an arbitrary value without changing the configuration of the semiconductor integrated circuit 20.

Also, in FIGS. 1 and 4, examples in which the resistive element R2 is a variable resistive element are shown. However, the resistive element R1 may be a variable resistive element instead of resistive element R2, or the resistive elements R1 and R2 may both be variable resistive elements.

While certain embodiments have been described, these embodiments have been presented by way of example only, and are not intended to limit the scope of the disclosure. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the disclosure.

What is claimed is:

1. A semiconductor integrated circuit, comprising:
a power supply voltage input terminal at which a power supply voltage is to be applied;
a feedback voltage output terminal at which a feedback voltage for controlling a level of the power supply voltage is to be output;
a feedback voltage generating unit configured to generate the feedback voltage corresponding to the level of the power supply voltage and including a variable resistive element; and
a resistance control unit configured to control a resistance value of the variable resistive element according to changes in a target level of the power supply voltage.

2. The semiconductor integrated circuit according to claim 1, wherein the feedback voltage generating unit includes a first resistive element and a second resistive element which are connected in series between the power supply terminal and a ground terminal.

3. The semiconductor integrated circuit according to claim 2, wherein
at least one of the first resistive element and the second resistive element is the variable resistive element, and
the feedback voltage is output from a connection node between the first resistive element and the second resistive element.

4. The semiconductor integrated circuit according to claim 3, wherein the resistance control unit is configured to control the resistance value of the variable resistive element such that a value of {R2/(R1+R2)} decreases when the target level of the power supply voltage is increased, and R1 is a resistance value of the first resistive element and R2 is a resistance value of the second resistive element.

5. The semiconductor integrated circuit according to claim 3, wherein the resistance control unit configured to control the resistance value of the variable resistive element to satisfy the following expression:
Vfb0=Vdd0*R2/(R1+R2)
when Vfb0 is a predetermined level for the feedback voltage, Vdd0 is the target level of the power supply voltage, R1 is a resistance value of the first resistive element, and R2 is a resistance value of the second resistive element.

6. The semiconductor integrated circuit according to claim 3, wherein the second resistive element is the variable resistive element.

7. The semiconductor integrated circuit according to claim 1, further comprising:
a target voltage setting unit configured to set the target level of the power supply voltage.

8. The semiconductor integrated circuit according to claim 7, wherein the target voltage setting unit is configured to set the target level of the power supply voltage on the basis of at least one of an operating speed of the semiconductor integrated circuit and a power consumption level of the semiconductor integrated circuit.

9. A semiconductor device, comprising:
a power supply voltage input terminal at which a power supply voltage is to be applied;
a feedback voltage output terminal at which a feedback voltage for controlling a level of the power supply voltage is to be output;
a feedback voltage generating unit configured to generate the feedback voltage corresponding to the level of the power supply voltage and including a variable resistive element;
a target voltage setting unit configured to set a target level for the power supply voltage; and
a resistance control unit configured to control the resistance value of the variable resistive element according to changes in the target level of the power supply voltage.

10. The semiconductor device of claim 9, wherein
the feedback voltage generating unit includes a first resistive element and a second resistive element that are connected in series between the power supply input and a ground terminal,
at least one of the first resistive element and the second resistive element is the variable resistive element, and
the feedback voltage is supplied from a connection node between the first and second resistive elements.

11. The semiconductor device of claim 10, wherein the resistance control unit configured to control the resistance value of the variable resistive element to satisfy the following expression:
Vfb0=Vdd0*R2/(R1+R2)
when Vfb0 is a predetermined level for the feedback voltage, Vdd0 is the target level of the power supply voltage, R1 is a resistance value of the first resistive element, and R2 is a resistance value of the second resistive element.

12. The semiconductor device of claim 11, wherein the target level of the power supply voltage is determined based on at least one of a desired operating speed of the semiconductor device and a power consumption level of the semiconductor device.

13. The semiconductor device of claim 9, wherein the target level of the power supply voltage is determined based on at least one of a desired operating speed of the semiconductor device and a power consumption level of the semiconductor device.

14. A power management system, comprising:
a power management device configured to control a power supply voltage that is supplied to a semiconductor integrated circuit such that a feedback voltage from the semiconductor integrated circuit approaches a predetermined value;
a feedback voltage generating unit configured to generate the feedback voltage corresponding to a level of the power supply voltage and including a variable resistive element; and
a resistance control unit configured to control a resistance value of the variable resistive element according to changes in a target level of the power supply voltage such that the feedback voltage approaches the predetermined value.

15. The power management system according to 14, wherein the feedback voltage generating unit is a part of the semiconductor integrated circuit.

16. The power management system according to 14, wherein the resistance control unit is a part of the semiconductor integrated circuit.

17. The power management system according to 14, wherein the feedback voltage generating unit is a first part of the semiconductor integrated circuit, and the resistance control unit is a second part of the semiconductor integrated circuit.

18. The power management system according to claim 14, further comprising:
a third resistive element and a fourth resistive element which are connected in series between feedback voltage output terminal of the semiconductor integrated circuit and a ground terminal, and provided outside of the semiconductor integrated circuit, a connection node between the third and fourth resistive elements being connected to the power management device.

19. The power management system according to claim 18, further comprising:
a target voltage setting unit configured to set the target level for the power supply voltage based on at least one of a desired operating speed of the semiconductor integrated circuit and a power consumption level of the semiconductor integrated circuit.

20. The power management system according to claim 14, further comprising:
a target voltage setting unit configured to set the target level for the power supply voltage.
